(19) United States
(12) Patent Application Publication
(10) Pub. No.: US 2014/0148590 A1
(43) Pub. Date: May 29, 2014

(54) FIBER BUNDLE

(71) Applicants: Ingo Bernt, Regensburg (DE); Matthew North, Bad Abbach (DE); Reinhold Röthenbacher, Pentling (DE); Walter Roggenstein, Bad Abbach (DE); Roland Scholz, Regensburg (DE)

(72) Inventors: Ingo Bernt, Regensburg (DE); Matthew North, Bad Abbach (DE); Reinhold Röthenbacher, Pentling (DE); Walter Roggenstein, Bad Abbach (DE); Roland Scholz, Regensburg (DE)

(73) Assignee: KELHEIM FIBRES GMBH, 93309 Kelheim (DE)

(21) Appl. No.: 14/232,822

(22) PCT Filed: Jun. 26, 2012
(86) PCT No.: PCT/EP2012/062375

§ 371 Date: Jan. 14, 2014

(30) Foreign Application Priority Data
Jul. 15, 2011 (EP) 11174141.9

(51) Int. Cl. C08B 16/00

(52) U.S. Cl. CPC C08B 16/00
USPC 536/57

(57) ABSTRACT

The present invention relates to a fiber bundle containing a plurality of regenerated multi-limbed cellulose fibers (1′,2′) the cross-sections of which exhibit three or more limbs. The fiber bundle according to the invention is characterized in that at least 10%, preferably at least 20%, particularly preferably at least 50%, of the multi-limbed cellulose fibers are asymmetrical fibers, wherein at least one of the limbs deviates in its length from the other limbs and wherein the length of one or several limbs is greater than the length of the shortest limb(s) by a factor of 2 to 10.

### BACKGROUND OF THE INVENTION

### Field of the Invention

The present invention relates to a fiber bundle which contains a plurality of regenerated cellulose fibers obtained by the viscose process.

A plurality of fibers can be understood as a “fiber bundle”, for example, spun rayon (a plurality of staple fibers), a strand of continuous filaments or a bale of fibers.

For sanitary applications such as, for example, tampons or absorbent bodies in general, fibers with a particularly high liquid storage capacity are desirable in order to thus allow an absorption capacity as high as possible of the sanitary product.

Fiber materials according to the prior art which usually are used for the production of tampons are regular viscose fibers, so-called trilobal viscose fibers and cotton. The specific absorption capacity of said fibers according to the so-called Syngina test as described further below is about 4.0 g/g for cotton, 4.5 g/g for regular viscose and 5.2 g/g for trilobal viscose fibers.

The aim of tampon producers is to achieve a particular degree of absorption with a minimum expenditure of fiber material and money.

While cotton is slowly becoming obsolete as a fiber material for tampons because of its insufficient absorption capacity, trilobal fibers are much more expensive to produce and it is far more difficult to process them into tampons, as compared to regular viscose.

Many different approaches for increasing the absorption capacity of cellulose fibers have been reported:

1. a chemical modification by grafting monomers onto the cellulose fiber

2. a chemical modification by incorporating absorbent polymers such as carboxymethyl cellulose, chitosan, cellulose carbamate, alginate or guaran into the cellulose fiber matrix

3. a physical modification of the fibers such as, e.g., hollow fibers or collapsed hollow fibers, as known, for example, from U.S. Pat. No. 4,129,679, or

4. multi-limbed fibers (so-called “trilobal” fibers) which are obtained by using spinnerets having multi-limbed extrusion holes with at least 3 limbs having a length-to-width ratio of 2:1 to 10:1, as known, for example, from EP-A1 0 301 874.

The disadvantage of a chemical modification of the cellulose fiber is that a costly and time-consuming toxicological and physiological test procedure is necessary for very delicate medical applications such as those of tampons and the occurrence of the toxic shock syndrome (TSS) keeps most tampon producers from using chemically modified fiber materials although the chemicals are possibly regarded as safe.

The disadvantage of hollow fibers and collapsed hollow fibers is that they are difficult to produce because of their high water retention capacity, as a result of which the fibers swell strongly during washing and adhere to each other during drying because of the formation of hydrogen bonds, which makes them brittle in the dry state, soapy in the wet state and renders it difficult to break them up and process them into a carded fabric.

In recent years, the use of multi-limbed, in particular trilobal fibers has experienced a steady increase.

The production of multi-limbed viscose fibers has been described, for example, in the U.S. Pat. Nos. 5,634,914 and 5,458,835 and in EP-A1 0 301 874. The process disclosed therein describes the spinning of a commonly used viscose, which may contain a certain amount of a modifier known from prior art, through extrusion holes of a multi-limbed shape, in particular a trilobal shape, into a conventional spinning bath. The essential feature of said process is that the shape of the multi-limbed extrusion holes in the spinneret is similar to the desired shape of the cross-section of the filaments. According to the teachings of those documents, the geometry of the spinneret hole determines the shape of the fiber cross-section, and a particular length-to-width ratio of the fiber cross-section can be obtained by designing the extrusion holes appropriately.

Moreover, the prior art with regard to multi-limbed fibers teaches that such multi-limbed fibers have an absorption capacity which is enhanced in comparison to that of viscose fibers according to the prior art, namely in particular in tampons, and that such fibers must have at least 3 limbs and that each limb of those fibers must exhibit a length-to-width ratio of at least 2:1, most preferably of from 3:1 to 5:1. The larger the length-to-width ratio, the higher would be the proportion of free volume and the absorption capacity of the fibers, provided that the limbs are not so long and thin that they will bend back onto themselves.

In those documents, it is also mentioned that, under the conditions of slow regeneration spinning, even higher absorption capacities of the multi-limbed fibers can be achieved, for example, by lowering the acid level and/or increasing the sulphate level and/or adding a viscose modifier.

The fact that hollow spaces in the cross-section of viscose fibers increase the absorption capacity of said fibers and of the products produced therefrom is furthermore known from U.S. Pat. No. 4,362,159.

From WO 2004/085720 A, a solid regenerated standard viscose fiber is known which has a cross-section the area of which is larger than the area of the largest equilateral triangle inscribed into said cross-section by a factor of less than 2.50 times, preferably less than 2.40 times, particularly preferably less than 2.25 times, and which exhibits a Syngina absorption capacity of more than 6.0 g/g fiber, as defined below.

WO 2004/005595 A describes an absorbent standard viscose fiber having an irregularly lobed cross-section. Further viscose fibers with irregular cross-sections are described in U.S. Pat. No. 4,129,679 and GB-A 1,333,047.

U.S. Pat. No. 6,403,217 B1 describes a variety of die configurations for the production of fibers having modified fiber cross-sections according to the melt spinning process. Melt spinning processes differ fundamentally from the wet spinning process used in the viscose process.

It is known that, in an absorbent body consisting of a plurality of fibers, the density of the absorbent body prior to the beginning of absorption has a significant influence on the specific absorption capacity of the structure. However, a lower density again leads to a reduced mechanical stability of the absorbent body, whereby the minimum applicable density has a lower limit.

In addition, a particular total absorption is often necessary for the desired product performance (e.g., in tampons pursuant to the EDANA Regulation) so that a compromise between maximum total absorption and maximum absorption capacity must be found.

Furthermore, a crimp of the fibers is advantageous for achieving good absorption properties in absorbent products. In this context, it is described in the prior art that fibers are to be crimped mechanically. It is also known to vary the method of fiber production such that an inhomogeneous fiber formation will occur. The two methods of producing a crimped fiber as known from the prior art either have not been used so far for viscose fibers or have yielded only inadequate results.

In order to overcome the above-mentioned disadvantages of known absorbent viscose fibers, according to the invention, a fiber bundle is provided which contains a plurality of regenerated multi-limbed cellulose fibers the cross-sections of which exhibit three or more limbs and which is characterized in that at least 10%, preferably at least 20%, particularly preferably at least 50%, of the multi-limbed cellulose fibers are asymmetrical fibers, wherein at least one of the limbs deviates in its length from the other limbs and wherein the length of one or several limbs is greater than the length of the shortest limb(s) by a factor of 2 to 10.

Further aspects of the present invention relate to a process for the production of the fiber bundle according to the invention as well as to the use of the cellulose fiber according to the invention and of the fiber bundle according to the invention.

### BRIEF DESCRIPTION OF THE FIGURES

FIG. 1 shows the attachment of two conventional fibers having trilobal cross-sections.

FIG. 2 shows the attachment of two fibers according to the invention having different limb lengths.

FIG. 3 shows the arrangement of several conventional fibers having trilobal cross-sections, assuming a packing of coordination number 6.

FIG. 4 shows the steric hindrance resulting from a completely asymmetrical configuration of fibers, with several fibers according to the invention being attached to each other.

FIG. 5 shows a fiber consisting of two trilobal basic shapes connected to each other at the ends of one of their limbs.

### DETAILED DESCRIPTION OF THE INVENTION

The present invention is based on the finding that, when the limb length and/or width of at least one of the limbs of a multi-limbed viscose fiber is/are changed, at the same degree of pressure the packing density of the fibers can be reduced in comparison to that of conventional trilobal viscose fibers.

For the purposes of the present invention, fibers in which at least one limb deviates in its length from the other limbs at the above-indicated rate are referred to as “asymmetrical”. Fibers which comprise, for example, two limbs of the same length and one limb which is longer than the two other limbs (hence, with only one limb deviating from the other limbs) likewise fall under the term “asymmetrical” for the purposes of the present invention (even if they can still exhibit at least one axis of symmetry).

In the asymmetrical cellulose fiber according to the invention, all of the limbs thereof preferably differ from each other with regard to their lengths. For the purposes of the present invention, those fibers are referred to as “completely asymmetrical” cellulose fibers.

It has also been found that a varying coagulation velocity during the entry into the spinning bath is achieved by an asymmetrical fiber cross-section. The result is thus the formation of a varying core/sheath structure across the fiber cross-section, resulting in a stronger crimp of the fiber according to the invention in comparison to a fiber of a higher symmetry.

In the fiber bundle according to the invention, at least 10%, preferably at least 20%, particularly preferably at least 50%, of the multi-limbed fibers contained therein are asymmetrical fibers. Preferably, all of the fibers contained in the fiber bundle are asymmetrical fibers. Particularly preferably, the cross-sections of all the asymmetrical fibers contained in the fiber bundle are essentially equal.

The fiber bundle may contain further fibers, for example, cellulose fibers which are not multi-limbed, but also fibers of a different origin, e.g., from other polymers.

The multi-limbed fibers according to the invention preferably exhibit a Y-shaped, i.e., “trilobal” cross-section. Other cross-sections such as, e.g., X-shaped cross-sections are possible as well.

In the fiber bundle according to the invention, at least one of the limbs in each of the asymmetrical cellulose fibers can preferably deviate from the other limbs also with regard to its width.

Preferably, in each of said asymmetrical cellulose fibers, the width of one or several limbs can be greater than the width of the narrowest limb by a factor of 1.1 to 5.

The angle between the limbs of the asymmetrical cellulose fibers can have from 80° to 140°.

At least a portion of the limbs of the asymmetrical fibers, preferably all the limbs, have a ratio of length to width of from 2:1 to 10:1.

The titer of the asymmetrical cellulose fibers may range from 1.3 dtex to 10 dtex.

The asymmetrical cellulose fibers can be provided in the form of staple fibers, filament fibers or short-cut fibers.

In a further embodiment of the asymmetrical cellulose fibers, their cross-section is formed of at least two multi-limbed basic shapes, which basic shapes are connected, in each case at least at one of their limb ends, to the limb end of another basic shape.

In said embodiment, the length of the connecting limb resulting from the connection of the two limb ends is preferably longer than the length of the shortest one of the other limbs by a factor of at least 1.5, preferably of from 1.5 to 2.0.

It has been found that, in multi-limbed cellulose fibers, a mere increase in the fiber titer by spinning a thicker fiber—with the cross-sectional shape remaining the same—does not bring about improved properties with regard to the absorbency of the fibers.

The preferred embodiment of a cellulose fiber formed of several multi-limbed basic shapes achieves said object in that, instead of an increase in the titer by proportionally increasing the fiber cross-section, a multiplication of the fiber cross-section occurs. Thus, several multi-limbed asymmetrical basic shapes are connected to each other at their limb ends so that a larger fiber thus having a higher titer emerges.

The process for the production of a fiber bundle according to the invention comprises the steps of
providing a viscose spinning mass
spinning the viscose spinning mass through several openings of a spinneret into a spinning bath, whereby filaments are formed,

wherein all the openings of the spinneret comprise three or more limbs, and is characterized in that at least 10% of the openings are asymmetrical openings, wherein at least one of the limbs deviates in its length and/or width from the other limbs, wherein the length of one or several limbs of the openings is greater than the length of the shortest limb(s) by a factor of 2 to 10.

Preferably, all openings are asymmetrical openings.

Preferably, in each of the asymmetrical openings, all limbs differ from each other with regard to their lengths.

Optionally, the process according to the invention may comprise the step of mixing the asymmetrical fibers produced by the process with other fibers, for example, symmetrical multi-limbed fibers (i.e., with the length and width, respectively, of all limbs being essentially equal), fibers which are not multi-limbed and/or fibers of a different origin, e.g., from other polymers.

A mixture of asymmetrical and symmetrical multi-limbed fibers can also be obtained by spinning through a spinneret the multi-limbed openings of which are partly asymmetrical and partly symmetrical.

In order to produce asymmetrical fibers in which at least one of the limbs deviates from the other limbs also with regard to its width, it should be envisaged appropriately for the asymmetrical openings that at least one of the limbs deviates in its width from the other limbs.

The present invention also relates to the use of a fiber bundle according to the invention in absorbent products, sanitary products, in particular tampons, incontinence products, sanitary pads and panty liners, filling materials for blankets, cushions and sleeping bags, packings for foodstuff, in particular for meat products, papers, in particular filter papers, flock, clothing, in particular inlay fleece and clothing textiles for moisture management, mixed with other fibers or as a multi-layered structure, and wound dressings.

### EXAMPLES

In a study, tampon plugs each having the same length, but different densities were pressed from conventional three-limbed viscose fibers (trademark “GALAXY®”) with three limbs of essentially the same length and the same width. Subsequently, the Syngina absorption (according to WSP 351.0) of the plugs was measured.

| | | | length | density |
|---|---|---|---|---|
| | Dry | absorption | prior to | prior to |
| | weight | Syngina | measurement | measurement |
| | [g] | [g/g] | [mm] | [g/cm³] |
| Sample 1 | 2.72 | 4.58 | 44.66 | 0.459 |
| Sample 2 | 2.74 | 4.67 | 46.95 | 0.440 |
| Sample 3 | 2.50 | 4.84 | 46.67 | 0.404 |
| Sample 4 | 2.61 | 4.77 | 46.99 | 0.419 |

The study shows that the absorption capacity of the absorbent body changes linearly with the density of the absorbent body at the beginning of the measurement.

It may be assumed that the coarser pore structure, which has developed in the less dense absorbent bodies, will result in higher absorption.

While, in the denser structure, a “collapse” or, respectively, a mutual adherence of the fibers may more easily occur because of the higher number of fibers which already lie directly parallel to each other, the larger distance between the fibers in the less dense structure will more readily result in “open” pores in which liquid can be stored.

Discussion of the decrease in density for a local 3-fold symmetry

### Example 1

FIG. 1 shows two fully symmetrical Y-fibers 1, 2, in which all limbs have essentially the same length and width. Those fibers may agglomerate very closely.

With a limb length of S=1, the mean distance (MA) of two fiber centers 3 and 4 MA=1.

### Example 2

An asymmetrical Y-fiber with an axis of symmetry has limb lengths Sa=1.5; Sb=0.75 and Sc=0.75, the fiber titer being the same as that of the fiber illustrated in FIG. 1.

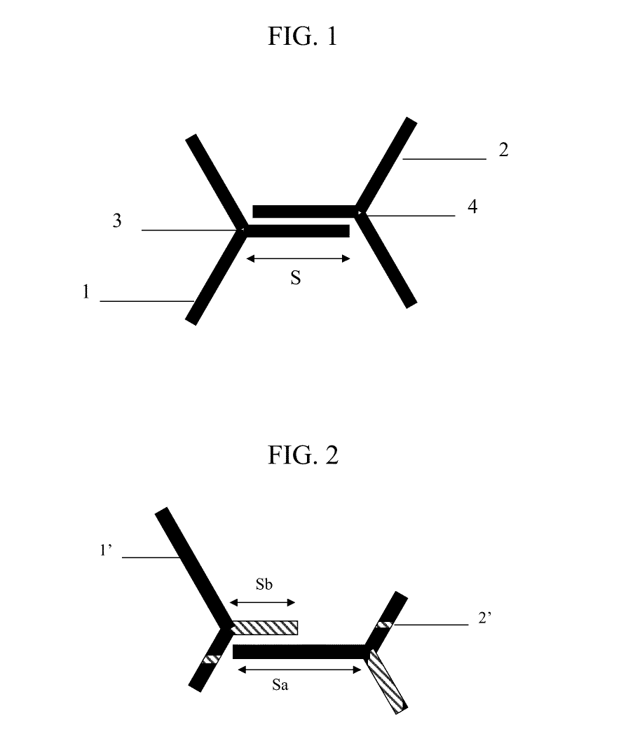

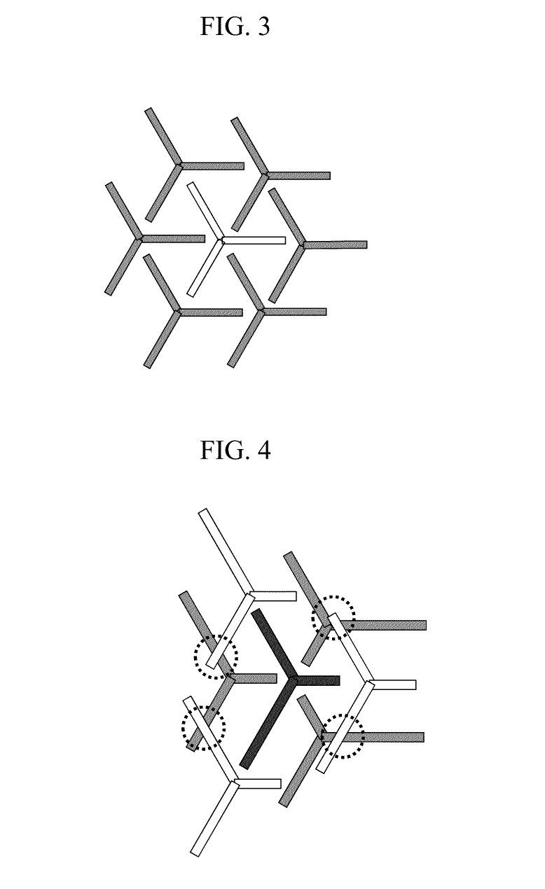

FIG. 2 shows a clustering of two such fibers 1′ and 2′ (for illustrative purposes, the longer limb is thereby depicted in a solid manner and the two shorter limbs are each depicted in a shaded manner).

The minimum distance between two individual fibers in close proximity is determined by the length of the respective longer wing (assuming completely rigid wings), as illustrated in FIG. 2.

Thus, the following ratio results for the distances around a fiber:

| | | |
|---|---|---|
| Sa(1) − Sa(2) = 1.5 | Sb(1) − Sa(2) = 1.5 | Sc(1) − Sa(2) = 1.5 |
| Sa(1) − Sb(2) = 1.5 | Sb(1) − Sb(2) = 0.75 | Sc(1) − Sb(2) = 0.75 |
| Sa(1) − Sc(2) = 1.5 | Sb(1) − Sc(2) = 0.75 | Sc(1) − Sc(2) = 0.75 |
| Mean value = 1.5 | mean value = 1.0 | mean value = 1.0 |

In total, a mean value of MA=(1.5+1+1)/3=1.17 thus results for the distance between two fibers.

### Example 3

An asymmetrical Y-fiber without elements of symmetry has limb lengths Sa=1.4; Sb=1.2 and Sc=0.4, with the fiber titer being the same.

The largest length:width ratio of the wings is thus not larger in this example than in Example 2.

Viewed in the same manner, the following distances result in this case:

| | | |
|---|---|---|
| Sa(1) − Sa(2) = 1.4 | Sb(1) − Sa(2) = 1.4 | Sc(1) − Sa(2) = 1.4 |
| Sa(1) − Sb(2) = 1.4 | Sb(1) − Sb(2) = 1.2 | Sc(1) − Sb(2) = 1.2 |
| Sa(1) − Sc(2) = 1.4 | Sb(1) − Sc(2) = 1.2 | Sc(1) − Sc(2) = 0.4 |
| Mean value = 1.4 | mean value = 1.27 | mean value = 1.0 |

In total, a mean value of MA=(1.4+1.27+1)/3=1.22 thus results for the distance between two fibers.

Thus, in the example, an increase in the average fiber distance
compared to the fully symmetrical fiber: of 22%
compared to the asymmetrical fiber of Example 2: of 8% results, in case of a maximum extension of a wing of the Y-structure in a completely asymmetrical fiber by 40%.

If, however, a packing model with the coordination number 6 is assumed for the agglomeration of several multi-limbed fibers, the possible attachment as illustrated in FIG. 3 will result.

For the arrangement of (in particular completely) asymmetrical fibers, a mathematical prognosis of the packing density is no longer possible in a descriptive way, since the asymmetrical fibers arrange themselves randomly and, therefore, a packing of the lowest possible density practically no longer occurs. In addition, a steric hindrance is caused by the different lengths of the wings, which prevents a packing of the fibers that is as dense as possible, as illustrated in FIG. 4 by way of circles.

Therefore, a fiber bundle which, according to the invention, contains asymmetrical fibers will result in products of a lower density during further processing or, respectively, pressing.

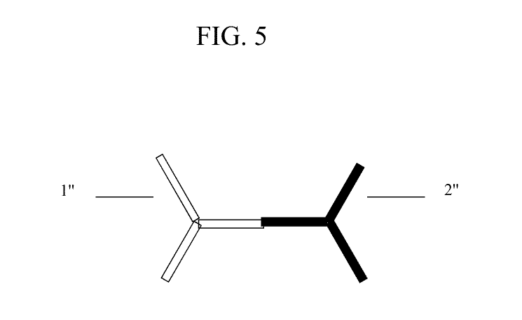

FIG. 5 shows a fiber consisting of two trilobal basic shapes 1″, 2″ (which, for illustrative purposes, are depicted in black and white, respectively) which are connected to each other at the ends of one of their limbs. The basic shapes shown in FIG. 5 are completely symmetrical, but may also be asymmetrical. The result is an asymmetrical cellulose fiber composed of two (or optionally also more) basic shapes which has a higher titer and—compared to fibers of a higher titer which consist only of one multi-limbed basic shape—increased absorbency.

1. A fiber bundle containing a plurality of regenerated multi-limbed cellulose fibers having cross-sections, wherein the cross-sections exhibit three or more limbs, wherein at least 10% of the multi-limbed cellulose fibers are asymmetrical fibers, wherein at least one of the limbs of said asymmetrical fibers deviates in its length from the other limbs and wherein the length of one or several limbs is greater than the length of the shortest limb(s) by a factor of 2 to 10.

2. The fiber bundle according to claim 1, wherein, in each of the asymmetrical cellulose fibers, all of the limbs thereof differ from each other with regard to their lengths.

3. The fiber bundle according to claim 1, wherein, in each of the asymmetrical cellulose fibers, at least one of the limbs deviates from the other limbs with regard to its width.

4. The fiber bundle according to claim 3, wherein, in each of the asymmetrical cellulose fibers, the width of one or several limbs is greater than the width of the narrowest limb by a factor of 1.1 to 5.

5. The fiber bundle according to claim 1, wherein, in each of the asymmetrical cellulose fibers, the angle between the limbs is from 80° to 140°.

6. The fiber bundle according to claim 1, wherein at least a portion of the limbs has a ratio of length to width of from 2:1 to 10:1.

7. The fiber bundle according to claim 1, wherein the asymmetrical cellulose fibers have a titer that ranges from 1.3 dtex to 10 dtex.

8. The fiber bundle according to claim 1, wherein the asymmetrical cellulose fibers are selected from the group consisting of staple fibers, filament fibers and short-cut fibers.

9. The fiber bundle according to claim 1, wherein at least a portion of the asymmetrical cellulose fibers have a cross-section that is formed of at least two multi-limbed basic shapes, which basic shapes are connected, in each case at least at one of their limb ends, to a limb end of another basic shape.

10. A process for the production of a fiber bundle according to claim 1, comprising the steps of
providing a viscose spinning mass
spinning the viscose spinning mass through several openings of a spinneret into a spinning bath, whereby filaments are formed,
wherein all the openings of the spinneret comprise three or more limbs, wherein at least 10% of the openings are asymmetrical openings, wherein at least one of the limbs of said asymmetrical openings deviates in its length from the other limbs, and wherein the length of one or several limbs of the openings is greater than the length of the shortest limb(s) by a factor of 2 to 10.

11. The process according to claim 10, wherein all openings are asymmetrical openings.

12. The process according to claim 10, wherein, in each of the asymmetrical openings, all limbs differ from each other with regard to their lengths.

13. The process according to claim 10, wherein, in the asymmetrical openings, at least one of the limbs deviates in its width from the other limbs.

14. A product comprising the fiber bundle according to claim 1, wherein the product is selected from the group consisting of absorbent products, sanitary products, filling materials, packings for foodstuff, papers, flock, clothing, and wound dressings.

15. The fiber bundle according to claim 1, wherein that at least 20% of the multi-limbed cellulose fibers are asymmetrical fibers.

16. The fiber bundle according to claim 15, wherein that at least 50% of the multi-limbed cellulose fibers are asymmetrical fibers.

17. The fiber bundle according to claim 6, wherein all the limbs have a ratio of length to width of from 2:1 to 10:1.

18. The product according to claim 14, wherein the sanitary product is selected from the group consisting of tampons, incontinence products, sanitary pads and panty liners.

19. The product according to claim 14, wherein the filling materials are for blankets, cushions and sleeping bags.

20. The product according to claim 14, wherein the packings are for meat products.

21. The product according to claim 14, wherein the papers are filer papers.

22. The product according to claim 14, wherein the clothing is inlay fleece.
